(19) United States
(12) Patent Application Publication
(10) Pub. No.: US 2020/0146476 A1
(43) Pub. Date: May 14, 2020

(54) Neck Pillow Device Stand

(71) Applicant: Jason Johnson, Scottsdale, AZ (US)

(72) Inventor: Jason Johnson, Scottsdale, AZ (US)

(21) Appl. No.: 16/682,613

(22) Filed: Nov. 13, 2019

Related U.S. Application Data
(60) Provisional application No. 62/767,409, filed on Nov. 14, 2018.

(51) Int. Cl. A47G 9/10; F16M 13/04

(52) U.S. Cl. CPC A47G 9/1045; H02J 7/0042; F16M 13/04; A47G 9/1081

(57) ABSTRACT

A pillow is disclosed. An illustrative embodiment of the pillow includes a neck pillow having extendable arms with electronic device clamps located and the ends of the arms. Pillow arms are articulable in various directions to allow adjustment of the electronic device for viewing. Some versions contain bluetooth functionality, a power source.

### CROSS-REFERENCE RELATED APPLICATIONS

This Application Claims Priority to U.S. Provisional Application No. 62/767,409, filed on Nov. 14, 2018, pending, which is incorporated by reference in its entirety.

### BACKGROUND

Generally, viewing a tablet, phone, or another personal electronic device while sitting or lying in a relaxed position requires the user to mount the device to some type of stand or to hold the device by hand. Using a stand usually means that the user must adapt their body to accommodate the screen's position. Users adapting themselves to their tools always results in ergonomic problems of one sort or another. And frequently these ergonomic problems cause health problems including strain-injury problem such as “tech neck”, or repetitive stress injuries.

Also, adjusting the stand to hold the device rarely results in convenient or satisfactory screen positioning. And any time the user moves, the screen is no longer aligned well.

When users hold the device in their hands, many of the problems disappear. But many just change. For example, neck strain may go away only to be replaced by wrist and finger strain. Additionally, manually holding a device leads to fatigue.

### SUMMARY

This disclosure contains a description of pillow embodiments of the current invention. These neck pillows have mechanical arms attached to the pillow to allow an electronic device to be suspended in front of a user of the pillow. Additionally, some neck pillow embodiments can be closed which stores the arm-holder assemblies inside the pillow. The arm-holder assembly comprises an arm and a minor arm with articulable connections between the arm and the minor arm. This articulation allows for adjustment of the electronic device to allow ergonomic, hands free, viewing of the electronic device. Additionally, device holders are mounted at the ends of the minor arms through a ball joint connector or other articulable connection. Various embodiments are disclosed in which the arm-holder assembly mounts in the pillow through a connection that is horizontally, vertically, or both horizontally and vertically articulable.

Some versions contain wireless connection modules adapted to connect the electronic device to the pillow. Yet other embodiments include a rechargeable power source contained in the pillow or earphones contained in the pillow. Methods of using the device are also disclosed.

In some method embodiments, the neck pillow is supplied and then opened by the user. After that, the user mounts the electronic device in the device holder or holders. After mounting, the user adjusts the electronic device for viewing. In these or other embodiments, the user can charge the electronic device using the rechargeable power source. Once use of the pillow is completed the user can close the pillow for storage.

### BRIEF DESCRIPTION OF FIGURES

FIGS. 1A and 1B are closed and open views of a neck pillow according to an embodiment of this invention.

FIG. 2 is an exploded view of an embodiment of the current invention.

FIG. 3 is a front-right perspective view of the neck pillow of FIG. 1.

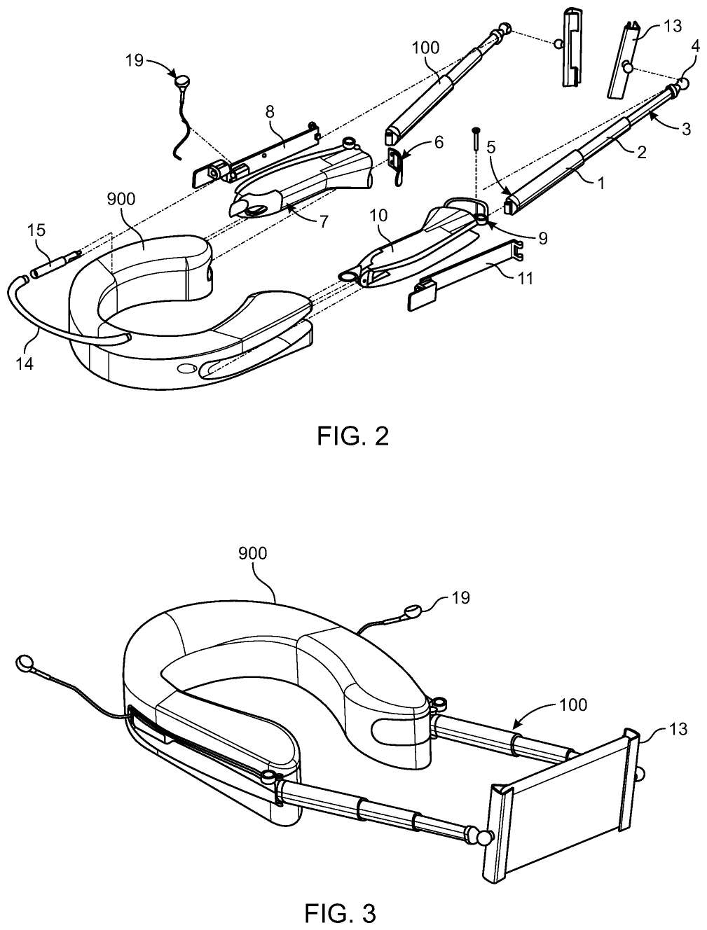

FIG. 4 is a perspective view of the neck pillow of an embodiment with arms extended.

FIG. 5 is a perspective view of the neck pillow of an embodiment with arms extended.

### DETAILED DESCRIPTION

The following description of several embodiments describes non-limiting examples that further illustrate the invention. No titles of sections contained herein, including those appearing above, are limitations on the invention, but rather they are provided to structure the illustrative description of the invention that is provided by the specification.

Unless defined otherwise, all technical and scientific terms used in this document have the same meanings that one skilled in the art to which the disclosed invention pertains would ascribe to them. The singular forms “a”, “an”, and “the” include plural referents unless the context clearly indicates otherwise. Thus, for example, reference to “fluid” refers to one or more fluids, such as two or more fluids, three or more fluids, etc. Any mention of an element includes that element's equivalents as known to those skilled in the art.

Any methods and materials similar or equivalent to those described in this document can be used in the practice or testing of the present invention. This disclosure incorporates by reference all publications mentioned in this disclosure all the information disclosed in the publications. The features, aspects, and advantages of the invention will become more apparent from the following detailed description, appended claims, and accompanying drawings.

This disclosure discusses publications only to facilitate describing the current invention. Their inclusion in this document is not an admission that they are effective prior art to this invention, nor does it indicate that their dates of publication or effectiveness are as printed on the document.

For purposes of this disclosure, “discrete” means lacking a physical connection to another object. For example, an object resting on the desk would be discrete from the desk. But if a screw connected the object to the desk, it would not be considered “discrete”. Likewise, if an object were resting on the battery, it would be discrete from the battery, but if it was connected to the battery with electrical wiring, it would not be discrete.

For purposes of this disclosure, “self-contained” means having all the components necessary for operation. For example, a self-contained medical device would contain all the components necessary for operating the medical device within the device itself. For purposes of this disclosure, “isolated” means not physically connected to another component of the system.

In one class of embodiments, the disclosed tablet or smart phone holder employs neck pillow or neck pad 900 containing shell assembly 10, 11 and interior hoop 14 as a platform to support left and right arms 1, 2, 3, 4, 5 collectively arms or telescopic arms 100. Clamps at the ends of arms 100, facilitate connecting left and right arms 1, 2, 3, 4, and 5 to the pillow 900.

The neck pad core 15 serves as the base. Hoop 14 attaches to right inner shell 10 and left inner shell 7. Right outer shell 11 attaches to right inner shell 10 and left outer shell 8 attaches to left inner shell 7. A left shell cover 6 attaches to an end of left inner shell 7, and right shell cover 9 attaches to right inner shell 10 completing the shell structure. Located behind shell cover 9 and controlled by buttons integral to shell cover 9, Bluetooth board 12 with full connection capabilities is attached to right inner shell 9, behind right outer shell 11 and contained within right inner shell 10; rechargeable battery 20 provides power to the unit.

Two or more telescopic sleeves 1, 2, 3 are nested and attached to create telescopic arm 100 for each side of the neck pillow 900. Proximal telescopic sleeve 1 attaches to arm hinge 5. Arm hinge 5 of each of arms 100 attaches to inner shells 7, 10 with a screw that also extends through outer shells 8, 11. This configuration allows arms 100 to rotate in a horizontal plane to allow for adjustment of arms 100. Distal telescopic sleeve 3 attaches to arm ball pivot 4. Arm ball pivot 4 attaches arm clamp 13 to the arms. Earbuds 19 are attached to neck pillow 900, sometimes through a connection with inner shells 7, 10.
Proximal telescopic sleeve 1
Various telescopic sleeves 2
Distal telescopic sleeve 3
Arm ball pivot 4
Arm hinge 5
Left shell cover 6
Left inner shell 7
Left outer shell 8
Right shell cover 9
Right inner shell 10
Right outer shell 11
Clamp 13
Hoop 14
Neck pad core 15
Earbuds 19
Telescopic arms or Telescopic support arms 100
Pillow 900
Support arm 1001
one or more Extension arms 1002, 1002′l
Arm connector 1004
Arm mount 1010
Arm-mount connector 1011
Device holder 1013
Minor arm 1030
Arm-mount cover 1031
Ball joint 1032
Arm-holder assembly 1035
Electronic controls 1400
Electronic control buttons 1400, 1402, 1403, 1404
Port 1410
Neck pad 2016

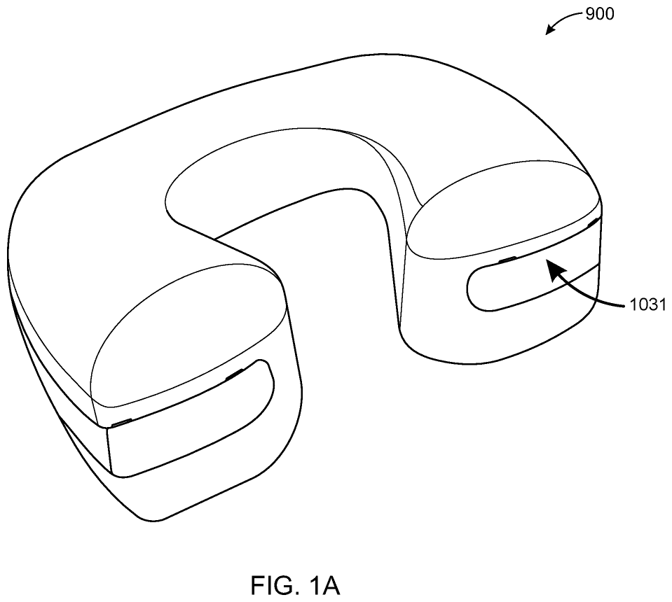

FIG. 1A depicts pillow 900 according to an embodiment of the current invention. In this figure, pillow 900 is shown in the closed position. FIG. 1B shows pillow 900 in an open or more extended position.

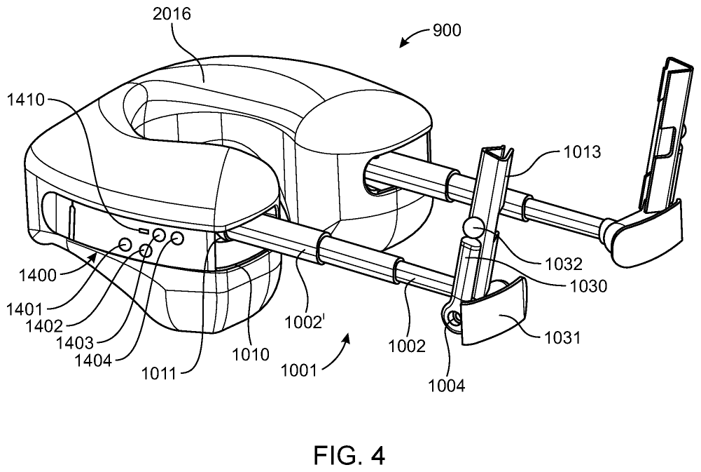

FIG. 4 depicts neck pillow 900 according to an embodiment of the invention. Neck pillow 900 has neck pad 2016; connecting arm mounts 1010 are inside of neck pad 2016. Arm mounts 1010 receive support arms 1001, connecting arms 1001 to pillow 900. Arm mounts 1010 also provide horizontal and vertical stability to support arms 1001. Ultimately, arm mounts 1010 connect to the electronic device and position the electronic device at an appropriate viewing distance, viewing angle, and height. Support arm 1001 mounts inside arm-mount 1010. Arm 1001 has one or more extensions 1002 that connect to allow arm 1001 to longitudinally extend from and retract into arm mounts 1010. In the embodiment shown in FIG. 4, extensions 1002 are oval-shaped tubes telescoped together. Those of ordinary skill in the art will recognize that the tubular shape and the telescoping arrangement are only one example of suitable ways to provide the longitudinal movement described above. In some versions, extensions 1002 have the functionality to adjust the extension position within a range of extension distances. In some embodiments, this adjusting functionality is implemented as a locking-type functionality using a friction fit between individual extensions. Other embodiments have extensions 1002 with detents along their length that fit into each other increasing the force needed to change the extension distance of arms 1001.

Arms 1001 terminate in arm connector 1004. Arm connector 1004 also connects to minor arm 1030. In some embodiments, arm connector 1004 allows adjustment of the angle between arm 1001 and minor arm 1030, sometimes in a vertical direction. In the embodiment shown in FIG. 4, connector 1004 employs a hinged configuration as the articulation joint. In other embodiments, connection 1004 may be a ball joint or any other type of articulation. Arm-mount cover 1031 is disposed at the end of arm 1001. Depending on the embodiment, arm-mount cover 1031 mounts to arm 1001, minor arm 1030, or both.

In some embodiments, minor arm 1030 is situated at 0, 15, 30, 45, 60, or 75° from vertical. Sometimes the angle between minor arm 1030 and arm 1001 is adjustable. Sometimes this adjustable angle is limited to the interval of −5 to 85, −5 to 45, −5 to 30, 0 to 45, or 0 to 30°.

In the embodiment shown in FIG. 4, minor arm 1030 extends upward from arm 1001. Device holder 1013 connects to end 1032 of minor arm 1030. This connection is articulable. In some embodiments, the articulable connection is a ball joint 1032. Ball joint 1032 allows adjustment of device holder 1013 to vary the angle between the surface of the electronic device mounted for viewing and the user's eyes. In some embodiments, manipulating the vertical position of the electronic device can be accomplished by sliding it up or down in electronic device holder 1013. Either one or the combination of ball joint 1032 and device holder 1013 allows adjustability of the electronic device to a position useful for viewing the electronic device.

In some embodiments, device holder 1013 is a U-shaped clamp that can removable grasp the electronic device. But many other ways of mounting an electronic device to a holder are known.

The complete arm-holder assembly 1035 has been described. Arm-holder assembly 1035 connects to arm-mount 1010 using one end of arm 1001, specifically through extension 1002′.

Arm-mount connector 1011 receives extension 1002′ or otherwise connects to extension 1002′. In the FIG. 4 embodiment, arm-mount connector 1011 is articulable in a horizontal plane. In these or other embodiments, arm-mount connector 1011 is articulable in a vertical direction. Articulability in the horizontal direction allows arm-holder assembly 1035 on each side of pillow 900 to move toward or away from a centerline of pillow 900 to accommodate longer or shorter electronic devices. Movement of arm-holder assembly 1035 away from the centerline causes device holders 1013 to move away from each other, resulting in a larger distance between device holders 1013 and vice versa. But those of ordinary skill in the art will recognize that other ways of adjusting the arms or the device holder to account for different lengths of electronic devices are known in the art.

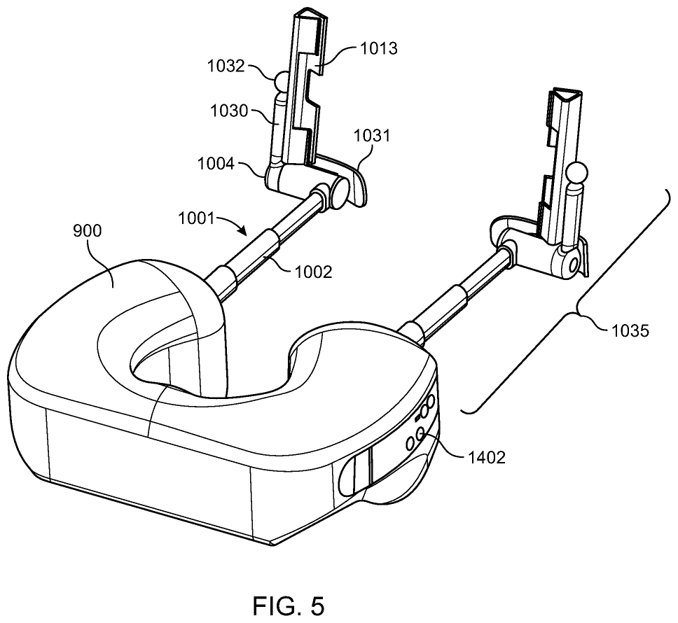

In a retracted or closed arrangement, arm-holder assembly 1035 (FIG. 5) is collapsed, substantially coaxially, so that arm-holder assembly 1035 can retract into arm-mount 1010 and in that arrangement, arm-mount cover 1031 sits flush with the surface of pillow 900. In some embodiments, arm-mount cover 1031 substantially conceals retracted arm-holder assembly 1035. This is shown in FIG. 1A, the closed position of pillow 900.

In some embodiments, pillow 900 additionally has earbuds 19 with wired or wireless connection to the electronic device. Sometimes the wireless connection occurs through a Bluetooth system. In some embodiments, pillow 900 comprises a power source for the electronic device.

FIG. 4 depicts a view of pillow 900 showing electronic controls 1400. The number, shape, and arrangement of electronic controls 1400 depends upon the specific electronic functionality included in the embodiment of the pillow. FIG. 4 shows a representation of four electronic controls 1400 including control buttons 1401, 1402, 1403, and 1404. These controls operate the electronics contained in pillow 900. Port 1410 represents input and output connections for pillow 900.

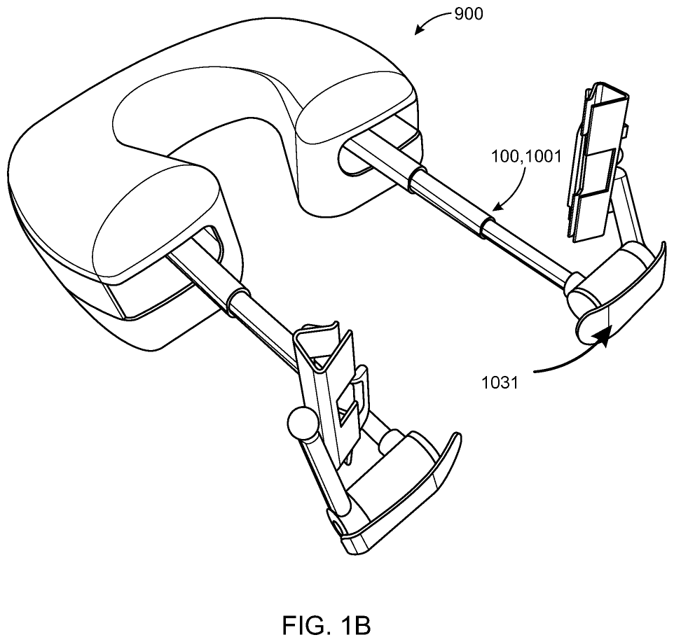

In operation of embodiments like the embodiment depicted in FIG. 2, a user would take the neck pillow 900 with tablet holder and place it around their neck while sitting or while laying down, such as sitting while riding in an airplane or using another transportation mode. The user would then extend the telescopic arms 100 out from the outer shells 8, 11 and rotate the telescopic arms 100 inwardly or outwardly, as needed. The user would then place their smartphone or tablet into the arm clamps 13 to secure the electronic device 18.

The user could connect earbuds 19 to electronic device 18 with the provided plug, or with integrated Bluetooth and place them into the user's ears. The user then can extend the telescopic arms 100 to position the electronic device at a comfortable viewing distance. The telescopic arms can also be moved to place the electronic device in the most comfortable viewing position vertically and horizontally. The user adjusts the angle of device arm clamps 13 by rotating the arms on arm ball pivots 4.

In operation of embodiments like the embodiment depicted in FIG. 4, a user would start out with the closed pillow 900 as shown in FIG. 1A. The next step would be extending arm-holder assembly 1035 on each side of pillow 900. This would free device holder 1013 to be adjusted in an approximate position for use. At that point, the electronic device can be inserted into device holder 1013 on each arm-holder assembly 1035.

Viewing distance would be adjusted by extending support arm 1001 out from arm mounts 1010 and adjusting minor arm 1030, arm connector 1004, and ball joint 1032. Depending on the electronic capabilities of the embodiment, various electronic controls 1400 are used to control functions of pillow 900. In appropriate embodiments, port 1410 supplies electrical power from a rechargeable power unit source (not shown) inside of pillow 900 to the electronic device. In versions of pillow 900 using wireless communication, the user would initialize the wireless connection between the electronic device and the pillow using whatever steps were appropriate for that particular wireless protocol.

While particular embodiments of the present invention have been shown and described, it will be obvious to those skilled in the art that changes and modifications can be made without departing from the embodiments of this invention in its broader aspects and, therefore, the appended claims are to encompass within their scope all such changes and modifications as fall within the true, intended, explained, disclose, and understood scope and spirit of this invention's multitudinous embodiments and alternative descriptions.

Additionally, various embodiments have been described above. For convenience's sake, combinations of aspects composing invention embodiments have been listed in such a way that one of ordinary skill in the art may read them exclusive of each other when they are not necessarily intended to be exclusive. But a recitation of an aspect for one embodiment is meant to disclose its use in all embodiments in which that aspect can be incorporated without undue experimentation. In like manner, a recitation of an aspect as composing part of an embodiment is a tacit recognition that a supplementary embodiment exists that specifically excludes that aspect. All patents, test procedures, and other documents cited in this specification are fully incorporated by reference to the extent that this material is consistent with this specification and for all jurisdictions in which such incorporation is permitted.

Moreover, some embodiments recite ranges. When this is done, it is meant to disclose the ranges as a range, and to disclose each and every point within the range, including end points. For those embodiments that disclose a specific value or condition for an aspect, supplementary embodiments exist that are otherwise identical, but that exclude the value or the conditions for the aspect.

1. A neck pillow comprising an arm assembly comprising an electronic device mount wherein the arm assembly suspends an electronic device in front of a user of the pillow.

2. The neck pillow of claim 1 further comprising another arm holder wherein
the arm-holder assemblies have an extended position and a retracted position,
and
the arm-holder assemblies are disposed inside the pillow in the retracted position.

3. The neck pillow of claim 2 wherein the arm holder assembly comprises an arm.

4. The neck pillow of claim 3 wherein an arm comprises two or more arm extensions.

5. The neck pillow of claim 4 wherein the arm assembly further comprises a minor arm.

6. The neck pillow of claim 5 wherein the arm connects to the device mount through an articulable connection to the minor arm.

7. The neck pillow of claim 6 wherein the minor arm connects to the device holder through an articulable connection.

8. The neck pillow of claim 7 wherein the arm assembly mounts in the pillow through a horizontally articulable connection.

9. The neck pillow of claim 8 wherein the device holder grips the electronic device.

10. The neck pillow of claim 9 further comprising a wireless connection module adapted to connect to the electronic device.

11. The neck pillow of claim 10 further comprising a rechargeable power source.

12. The neck pillow of claim 11 further comprising earbuds.

13. The neck pillow of claim 1 wherein the minor arm connects to an arm extension through an articulable connection.

14. The neck pillow of claim 13 further comprising a rechargeable power source.

15. The neck pillow of claim 14 further comprising a wireless connection module adapted to connect to the electronic device.

16. A method comprising:
supplying the neck pillow of claim 1;
opening the pillow;
and
mounting an electronic device in the device holder or holders.

17. The method of claim 16 further comprising adjusting the electronic device for viewing by a user of the neck pillow.

18. The method of claim 17 further comprising charging the electronic device using a chargeable power source contained in the pillow.

19. The method of claim 18 further comprising closing the pillow.
